(19) United States
(12) Patent Application Publication
(10) Pub. No.: US 2025/0047234 A1
(43) Pub. Date: Feb. 6, 2025

(54) ROOF SHEET

(71) Applicant: SAWAYA CO., LTD., Kanazawa (JP)

(72) Inventor: Toshiro OZAKI, Kanazawa (JP)

(21) Appl. No.: 18/792,550

(22) Filed: Aug. 2, 2024

(30) Foreign Application Priority Data
Aug. 4, 2023 (JP) 2023-127624

(51) Int. Cl. H02S 20/25; H02S 40/42

(52) U.S. Cl. CPC H02S 20/25; H02S 40/425

(57) ABSTRACT

A roof sheet that is fixed over a folded-plate roof via fasteners, at least, includes a main body sheet provided with multiple ventilation permeation holes, and a solar power module having flexibility that is fixed to a position on the surface of the main body sheet that does not block the ventilation permeation holes.

### TECHNICAL FIELD

This invention relates to a roof sheet that can decrease heat conduction into the room of a building by laying it on its roof, and further provide a high energy-saving effect by having a power generation function.

### BACKGROUND ART

There is a problem that roofs of ordinary houses, buildings, factories, storages, etc. become high in temperature by direct sunlight, and that the heat is conducted to make the indoor space high in temperature. There is also a problem that due to radiative cooling from the roof, the room temperature drops, reducing heating efficiency and forming condensation water that drops onto the room floor. Especially, because folded-plate roofs used for large-scale buildings such as factories and storages are processed by bending metallic plates, they have high heat conductivity, significantly causing such a problem.

Then, although known are measures such as applying a heat-shielding paint on the roof, making a double roof (layered roof), and greening the rooftop, they all have problems such as taking more time in construction and more labor in maintenance. The applicant of this application has developed a shielding roof sheet that is attached to the apexes of a folded-plate roof via fasteners (Patent Document 1). Because this sheet is made of a material having a property to shield rain and light and has many permeation holes, it reflects sunlight and also allows airflow naturally occurring in a space between the roof surface and the sheet to pass through the permeation holes and diffuse to the outside, thereby efficiently suppressing the temperature rise of the roof surface and the occurrence of condensation.

### RELATED DOCUMENTS

### Patent Documents

[Patent Doc. 1] JP Patent 4792059

### Problems to be Solved

In light of the soaring electricity bills in recent years, a roof sheet that allows a higher energy-saving effect than the technology related to the above-mentioned Patent Document 1 is demanded.

Considering the above problems, this invention has an objective to offer a roof sheet that can be laid on the roof of a building to allow a high energy-saving effect by decreasing heat conduction into the room and having a power generation function.

### SUMMARY

A roof sheet of the present invention that is fixed over a folded-plate roof via fasteners, at least includes a main body sheet provided with multiple ventilation permeation holes, and a solar power module having flexibility that is fixed to a position on the surface of the main body sheet that does not block the ventilation permeation holes.

A roof sheet of the present invention fixed over a folded-plate roof via fasteners includes a solar power module having flexibility, wherein the solar power module is provided with multiple ventilation permeation holes.

### Advantage(s) of Invention

Because the roof sheet of this invention has a power generation function using a solar power module, a high energy-saving effect can be obtained.

Because the solar power module has flexibility, even if its main body sheet is bent by wind, snow, or the like, the solar power module can bend following the movement of the main body sheet.

The fasteners create a space between the roof sheet and the folded-plate roof. Airflow naturally occurring inside the space reach the outside through the ventilation permeation holes, which generates a heat dissipation effect, thereby suppressing temperature rise inside the building and the occurrence of condensation. Especially, although the exposure to sunlight can heat up the solar power module itself and reduce its power generation efficiency, the airflow passing through the ventilation permeation holes can also provide the effect of lowering the temperature of the solar power module.

In addition, obtained are the effects that even in strong winds, air passes through the ventilation permeation holes, preventing the roof sheet from fluttering or being damaged by wind, and that rainwater pooled on the roof sheet surface is drained to the roof through the ventilation permeation holes.

In addition, the existence of the roof sheet blocks direct sunlight onto the roof, which can suppress the temperature rises of the roof and the building interior.

If the solar power module itself is provided with ventilation permeation holes, the costs of manufacturing and installation of the roof sheet can be reduced.

### BRIEF DESCRIPTIONS OF DRAWINGS

FIGS. 1A and 1B are (A) a plan view and (B) a front view showing the state where the roof sheet of the first embodiment is fixed to a folded-plate roof.

FIGS. 2A and 2B are (A) a plan view and (B) a plan view showing modification examples of the roof sheet.

FIG. 3 is a partial enlarged plan view of the roof sheet.

FIGS. 4A, 4B, and 4C are (A) an enlarged plan view and (B) an enlarged front view showing the state where the roof sheet is fixed to a seam-jointed folded plate, and (C) a front view of a fastener.

FIGS. 5A and 5B are (A) an enlarged plan view and (B) a front view showing the state where the roof sheet is fixed to stacked folded plates.

FIG. 6 is a plan view showing the state where the roof sheet of the second embodiment is fixed to a folded-plate roof.

### PREFERRED EMBODIMENT(S)

### First Embodiment

The first embodiment of the roof sheet of this invention is explained.

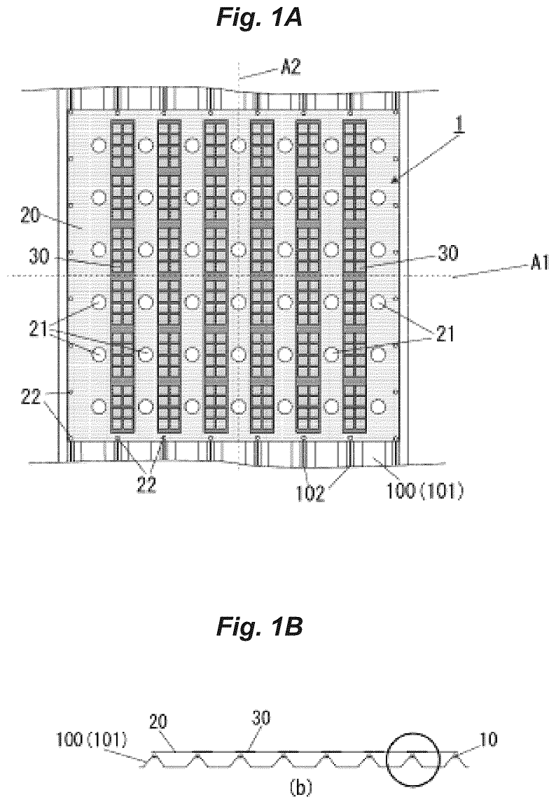

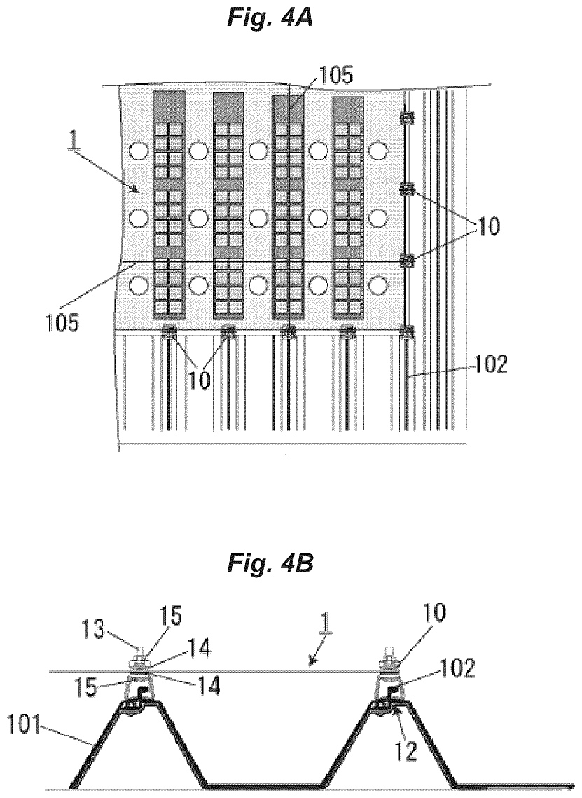

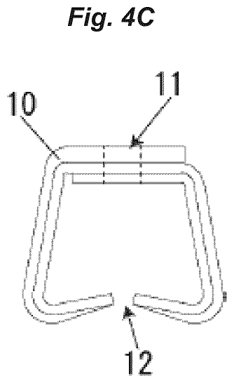

As shown in FIG. 1, a roof sheet 1 is fixed over a folded-plate roof 100 via fasteners 10. Note that the fasteners 10 are not shown in FIG. 1A, and a plan view of the roof sheet 1 fixed using the fasteners 10 is shown in FIG. 4A.

The roof sheet 1 is provided with a main body sheet 20 and solar power modules 30 at least.

The main body sheet 20 should preferably have rain and light shielding properties, and be made of polyethylene-based resin, but not limited to it.

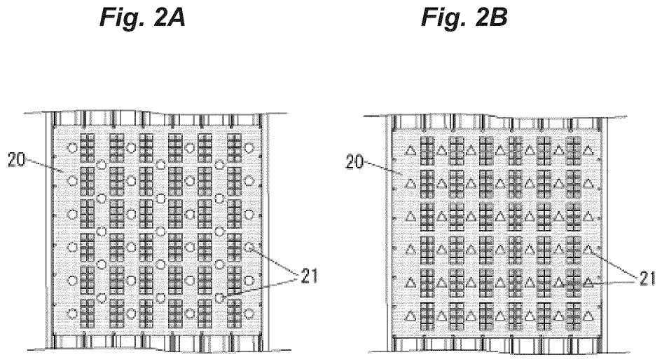

The main body sheet 20 is provided with multiple ventilation permeation holes 21. Although the ventilation permeation holes 21 are basically installed at specified intervals on the whole surface of the main body sheet 20, they can be installed on part of the main body sheet 20. The method of arranging the ventilation permeation holes 21 is not particularly limited, and they can be arranged at even intervals in the up-down and right-left directions as shown in FIG. 1A, or arranged alternately as shown in FIG. 2A. Although the diameter of the ventilation permeation holes 21 can be adjusted appropriately according to the place where the roof sheet 1 is installed, about 80-150 mm is preferable. In addition, the shape of the ventilation permeation holes 21 is not limited to a circular shape but can be a polygon such as a triangle or a quadrilateral as shown in FIG. 2B.

Installed on the edges of the main body sheet 20 are multiple eyelets 22 at even intervals. The eyelets 22 are used for fixing the roof sheet 1 to the folded-plate roof 100. As mentioned later, although a seam-jointed folded plate 101 allows fixing with screws or bolts and nuts utilizing the eyelets 22, on stacked folded plates 103 the edges are clamped and fixed, therefore the eyelets 22 are not necessarily required. In addition, not being limited to the eyelets 22, any holes that allow fixing with screws or bolts and nuts can be adopted.

The solar power modules 30 are fixed to positions that do not block the ventilation permeation holes 21 on the main body sheet 20. Each solar power module 30 is made by arranging solar cells provided with resin substrate so as to obtain desired electric voltage and current and laminating them with a resin sheet made of ETFE (Ethylene Tetra Fluoro Ethylene) or the like in an electrically-connected state, and has flexibility. By electrically connecting multiple solar power modules 30, a solar cell array is made.

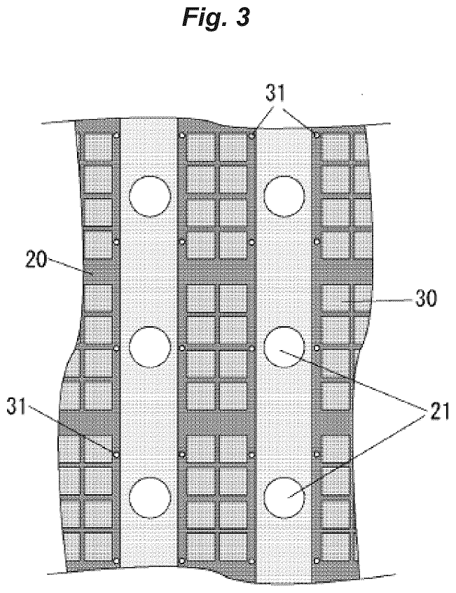

As the method of fixing the solar power modules 30 onto the surface of the main body sheet 20, welding, bonding with a glue or adhesive tape, and connecting with a commonly-known means such as bolts and nuts are listed for example, but it is not limited to them. For example, as shown in FIG. 3, a method can be adopted that eyelets 31 are installed on the edges of each solar power module 30, bolts are passed through the eyelets 31 and fixed with nuts from the back side of the main body sheet 20 and the front side of the solar power module 30.

Because the solar power modules 30 have flexibility, even if the main body sheet 20 is bent by wind, snow, or the like, the solar power modules 30 can bend following the movement of the main body sheet 20. In addition, because they can be folded at places shown in lines A1 and A2 in FIG. 1, the portability and workability of the roof sheet 1 can be enhanced.

Note that although not depicted here, electricity generated by the solar power modules 30 is stored in batteries via a power conditioner, etc.

The structure of the fastener 10 is not particularly limited, and an example of its structure is shown below.

FIG. 4B is an enlarged view of the part surrounded with a circle in FIG. 1B, showing the state where the roof sheet 1 is fixed to the seam-jointed folded-plate 101 via the fasteners 10.

As shown in FIG. 4C, the fastener 10 has a trapezoidal cross section and is provided with an opening 11 at its top and a groove 12 at its bottom. By fitting a rail-shape protrusion 102 on the apex of the seam-jointed folded plate 101 with the groove 12, the fastener 10 is fixed to the seam-jointed folded plate 101.

As shown in FIG. 1A, the eyelets 22 are formed at specified intervals on the edges of the main body sheet 20, and as shown in FIG. 4B, bolts 13 are passed through the eyelets 22 and the openings 11 of the fasteners 10 as they are overlaid, and the top and bottom of the bolts 13 are tightened with nuts 15 via washers 14, thereby fixing the roof sheet 1 fixed over the seam-jointed folded plate 101 via the fasteners 10.

In addition, as shown in FIG. 4A, placing wires 105 on the surface of the roof sheet 1, both ends of the wires 105 can be fixed with the fasteners 10. In this case, the wires 105 can push down the roof sheet 1 trying to float up by wind.

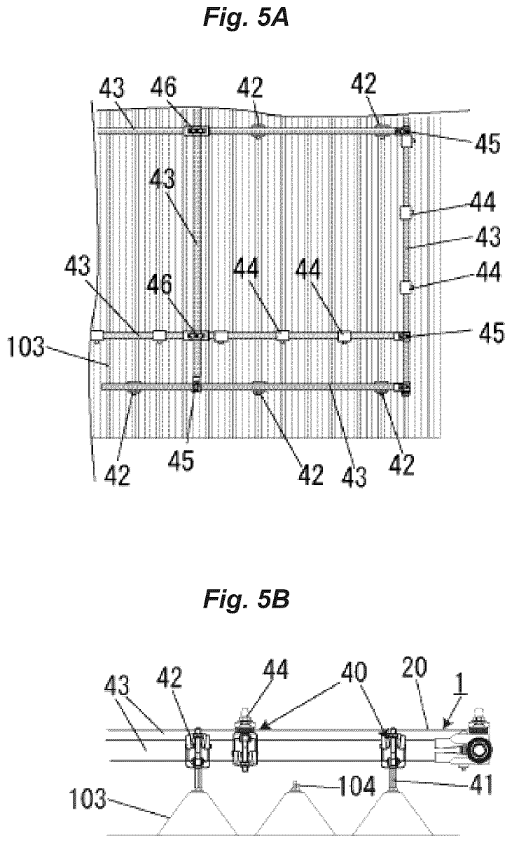

FIG. 5 shows the state where the roof sheet 1 is fixed to the stacked folded plates 103 via a fastener 40. Not that in order to facilitate understanding, the roof sheet 1 is not shown in FIG. 5A.

The fastener 40 is roughly composed of high nuts 41, base clamps 42, single pipes 43, seat clamps 44, T-clamps 45, cross clamps 46, etc.

On the apexes of the stacked folded plates 103, many nuts 104 are attached for fixing two stacked pieces of roof materials. The high nuts 41 are attached to part of these nuts 104, and the base clamps 42 are attached to the upper part of the high nuts 41. Next, the multiple single pipes 43 are assembled into a rectangular shape in plan view as holding them with the base clamps 42. Next, the multiple single pipes 43 are assembled into a rectangular shape in plan view with the T-clamps 45, cross clamps 46, etc., and the edges of the main body sheet 20 are held by the multiple seat clamps 44 attached to the single pipes 43, thereby fixing the main body sheet 20 to the stacked folded plates 103.

### Second Embodiment

Next, the second embodiment of the roof sheet of this invention is explained, where the parts having the same configuration as those in the first embodiment mentioned above are given the same codes, and their explanations are omitted.

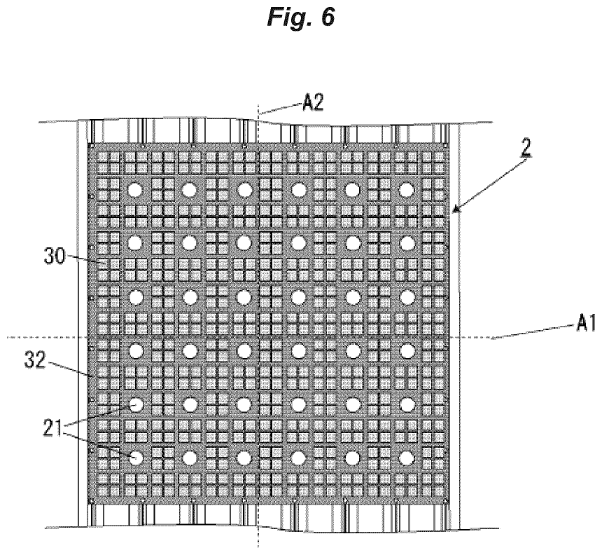

As shown in FIG. 6, this embodiment is characterized in that it is not provided with the main body sheet 20 shown in the first embodiment, and that the solar power module 30 itself is provided with the ventilation permeation holes 21.

Specifically, the ventilation permeation holes 21 are formed on a back sheet 32 placed at the bottom layer of the solar power modules 30. The solar power modules 30 are arranged so as not to block the ventilation permeation holes 21.

Because the roof sheet 2 of this embodiment is not provided with the main body sheet 20, the costs of manufacturing and installation can be reduced.

### INDUSTRIAL APPLICABILITY

This invention is a roof sheet that can decrease heat conduction into the room of a building by laying it on its roof and further has a power generation function, thereby providing a high energy-saving effect. Therefore, it has industrial applicability.

### EXPLANATIONS OF CODES

1: Roof sheet
2: Roof sheet
10: Fasteners
11: Openings
12: Grooves
13: Bolts
14: Washers
15: Nuts
20: Main body sheet
21: Ventilation permeation holes
22: Eyelets
30: Solar power modules
31: Eyelets
32: Back sheet
40: Fasteners
41: High nuts
42: Base clamps
43: Single pipes
44: Scat clamps
45: T-clamps
46: Cross clamps
100: Folded-plate roof
101: Scam-jointed folded plate
102: Protrusions
103: Stacked folded plates
104: Nuts
105: Wires

What is claimed is:

1. A roof sheet that is fixed over a folded-plate roof via fasteners, at least comprising:
a main body sheet provided with multiple ventilation permeation holes, and
a solar power module having flexibility that is fixed to a position on the surface of the main body sheet that does not block the ventilation permeation holes.

2. A roof sheet fixed over a folded-plate roof via fasteners, comprising:
a solar power module having flexibility, wherein
the solar power module is provided with multiple ventilation permeation holes.
